(19) United States
(12) Patent Application Publication
(10) Pub. No.: US 2026/0073377 A1
(43) Pub. Date: Mar. 12, 2026

(54) MICROTRANSACTIONS FOR WEB 3.0 AND METAVERSE

(71) Applicant: MASTERCARD ASIA/PACIFIC PTE. LTD., Singapore (SG)

(72) Inventors: Donghao Huang, Singapore (SG); Bensam Joyson, Singapore (SG); Dendy Gunawan, Singapore (SG); Gerald Ng, Singapore (SG); Oskar Duris, Walnut Creek, CA (US); Rashi Goyal, Plainsboro, NJ (US); Shi Ler Shila Chew, Singapore (SG); Soumyajit Mitra, London (GB)

(21) Appl. No.: 18/882,355

(22) Filed: Sep. 11, 2024

(51) Int. Cl. G06Q 20/22; G06Q 20/06; G06Q 20/36; G06Q 20/38; G06Q 20/40

(52) U.S. Cl. CPC G06Q 20/29; G06Q 20/065; G06Q 20/3672; G06Q 20/389; G06Q 20/405

(57) ABSTRACT

Systems and techniques for facilitating microtransactions are described. The described systems and techniques leverage certain capabilities of the blockchain while maintaining a conventional transaction experience and/or interface. A method includes receiving, at a digicent service on a blockchain, a digital currency microtransaction request to transfer a particular amount of digital currency from a first digicent wallet account to a second digicent wallet account, the microtransaction being a fractional fiat currency transaction. The digicent service verifies the digital currency microtransaction request, including by confirming that a first tokenized payment source is associated with the first digicent wallet account and exists as a valid smart contract on the blockchain; and confirming that a second tokenized payment source is associated with the second digicent wallet account and exists as a valid smart contract on the blockchain.

### BACKGROUND

A microtransaction is a transaction having a relatively small payment amount, including fractions of a dollar or even fractions of a cent. Indeed, today, microtransactions are applicable to a large variety of purchases, including digital donations to online content to creators, subscriptions for online services, small-in-game purchases, and purchases of dissected content (e.g., a single article from a major online news organization.) However, it is costly to efficiently and effectively implement microtransaction payments given the current technological and financial restrictions of the conventional online economic ecosystem.

There are several challenges for efficiently and effectively implementing microtransactions in the current web2 and emerging web3 environments. Currently, enabling micropayments requires businesses to build a storefront system and wrestle with the high transaction costs for credit card processing of micropayments. Given the processing requirements and systems that are still required despite the low profit/value of transactions, these types of transactions can be costly for both the user and provider and often result in far fewer microtransactions occurring.

Additionally, there is a lack of interoperability in payment systems and solutions, meaning that micropayment solutions are not widely available. Most micropayment solutions today revolve around a web3 interface, for example making micropayments using web3 (e.g., cryptocurrency). However, current web3 technology has a high technological learning curve, making it difficult for many users to interact with and reliably use. Currently, payment in web3 often relies on web3 specific tokens, either as a cryptocurrency tokens or as other platform-specific credit. This locks funds to a specific ecosystem, and in the case of cryptotokens, the price is volatile due to the volatile nature of cryptocurrency. Even for cases where payment is in fiat currencies, users would need to enter their payment method on each platform that they want to make payment with. As such, current web3 solutions/options for micropayments have a high barrier of entry for mass adoption.

### BRIEF SUMMARY

Systems and techniques for facilitating microtransactions are described. The described systems and techniques leverage certain capabilities of the blockchain while maintaining a conventional transaction experience and/or interface.

In some aspects, the techniques described herein relate to a method, including: receiving, at a digicent service on a blockchain, a digital currency microtransaction request to transfer a particular amount of digital currency from a first digicent wallet account to a second digicent wallet account, wherein the digital currency microtransaction request includes a purchase identifier (ID) and the particular amount, and wherein a microtransaction is a fractional fiat currency transaction; verifying, at the digicent service, the digital currency microtransaction request, wherein verifying the digital currency microtransaction request includes: confirming that a first tokenized payment source is associated with the first digicent wallet account and exists as a valid smart contract on the blockchain; and confirming that a second tokenized payment source is associated with the second digicent wallet account and exists as a valid smart contract on the blockchain; and in response to verifying the digital currency microtransaction request, transferring the particular amount of digital currency from the first digicent wallet account to the second digicent wallet account.

In some aspects, the techniques described herein relate to a system including: a processing system; one or more storage media; and instructions stored on the one or more storage media that, when executed by the processing system, direct the processing system to at least: receive, at a digicent service on a blockchain, a digital currency microtransaction request to transfer a particular amount of digital currency from a first digicent wallet account to a second digicent wallet account, wherein the digital currency microtransaction request includes a purchase identifier (ID) and the particular amount, and wherein a microtransaction is a fractional fiat currency transaction; verify, at the digicent service, the digital currency microtransaction request, wherein the instructions that direct the digicent service to verify the digital currency microtransaction request further direct the system to: confirm that a first tokenized payment source is associated with the first digicent wallet account and exists as a valid smart contract on the blockchain; and confirm that a second tokenized payment source is associated with the second digicent wallet account and exists as a valid smart contract on the blockchain; and in response to verifying the digital currency microtransaction request, transfer the particular amount of digital currency from the first digicent wallet account to the second digicent wallet account.

In some aspects, the techniques described herein relate to one or more computer readable storage media having instructions stored thereon that, when executed by a processing system, direct the processing system to perform a method including: receiving, at a digicent service on a blockchain, a digital currency microtransaction request to transfer a particular amount of digital currency from a first digicent wallet account to a second digicent wallet account, wherein the digital currency microtransaction request includes a purchase identifier (ID) and the particular amount, and wherein a microtransaction is a fractional fiat currency transaction; verifying, at the digicent service, the digital currency microtransaction request, wherein verifying the digital currency microtransaction request includes: confirming that a first tokenized payment source is associated with the first digicent wallet account and exists as a valid smart contract on the blockchain; and confirming that a second tokenized payment source is associated with the second digicent wallet account and exists as a valid smart contract on the blockchain; and in response to verifying the digital currency microtransaction request, transferring the particular amount of digital currency from the first digicent wallet account to the second digicent wallet account.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example scenario of a microtransaction of a fractional payment amount.

FIG. 2 illustrates an example operating environment for the digicent service.

FIG. 3A illustrates an example process for funding a digicent wallet account.

FIGS. 3B-3D illustrate example representations of digicent wallet account management in graphical user interface of a partner application supporting a digicent service.

FIG. 4A illustrates an example method for facilitating a microtransaction at a digicent service from a first digicent wallet account to a second digicent wallet account.

FIG. 4B illustrates a process for topping up a digital currency balance of a digicent wallet account.

FIG. 5 illustrates a process of making a payment using a digicent wallet account that does not have a sufficient digicent balance.

FIG. 6 illustrates an example process for cashing out digicents for fiat currency.

FIG. 7A illustrates an example process funding a digicent wallet account using a financial NFT.

FIG. 7B illustrates an example process for topping up a user's digicent wallet account using a financial NFT.

FIG. 8 illustrates an example scenario for a digicent microtransaction originating at an online merchant.

FIG. 9 illustrates an example scenario for a digicent microtransaction originating at a point-of-sale (POS) terminal.

FIG. 10 illustrates components of a computing system that may be used in certain embodiments described herein.

### DETAILED DESCRIPTION

Systems and techniques for facilitating microtransactions are described. The described systems and techniques leverage certain capabilities of the blockchain while maintaining a conventional transaction experience and/or interface.

### Definitions

“Cryptocurrency” (“crypto”) refers to a digital currency in which transactions are verified and records maintained by a decentralized system using cryptography, rather than by a centralized authority. Examples of cryptocurrency include Bitcoin, Ethereum, Tether, Solana, and Dogecoin.

“Stablecoin” refers to a type of cryptocurrency whose value is pegged to another asset, such as a fiat currency or gold, to maintain a stable price.

“Decentralized applications” (“dApps”) refers to an application that can operate autonomously, typically through the use of smart contracts, that run on a decentralized computing, blockchain, or other distributed ledger system.

“Blockchain gas fee” (“gas fee”) refers to the cost that certain blockchain protocol users pay to network validators each time they wish to perform a function on the blockchain.

“Fiat currency” refers to a government-issued currency that is not backed by a physical commodity, such as gold or silver, but rather by the government that issued it. Examples of fiat currency include, but are not limited to, the U.S. dollar, the British pound, the Indian rupee, and the euro.

“Non-fungible tokens” (“NFTs”) refer to digital tokens on a blockchain, each of which represents a distinct digital/physical asset. Each NFT is unique and cannot be swapped for another version of itself.

As used herein, a “financial NFT” refers to a publicly verifiable and non-transferable NFT that represents a tokenized payment card. Each financial NFT can be powered by, for example, ERC-721 smart contracts deployed on the supported blockchains. Each financial NFT has multiple on-chain data elements, such as, but not limited to, Token ID: unique identifier, Token URI: link to metadata, Hashed primary account number (“PAN”): one-way hash of PAN, and Status: active/inactive/blocked. Token metadata can be stored in peer-to-peer distributed file systems, e.g., InterPlanetary File System (IPFS) and can contain data elements (in JSON format) such as, but not limited to, name, description, image, and list of customized attributes.

An example code listing for a financial NFT includes:

```
{
      “name”: “**** 3821”,
        “description”: “Payment Card, ending 3821”,
        “image”: “ipfs://QmWtmlnLSADTBhjUVmr4Hj9QWBnnxjSkk78DEb3uBJdQ8w”,
        “attributes”: [
    {
      “trait_type”: “ownerAddress”,
      “value”: “0x507222b2eA12829882210ab5fb6d4868199d835e”
    },
    {
      “trait_type”: “hashedPAN”,
      “value”: “3145269513c69897a766b343be61736803a3f58904bc3c7c1ab51f5c72769b3a”
    },
    {
      “trait_type”: “tokenAPI”,
      “value”: “https://card-nft.com/tokens″
    }
  ]
}
```

“Tokenization” refers to the process of replacing a card's primary account number (PAN)—the 16-digit number on the plastic card—with a unique alternate card number, or “token.” Tokens can be used for mobile point-of-sale transactions, in-app purchases or online purchases.

“Minting an NFT” refers to the process of publishing a digital asset on the blockchain.

A “smart contract” refers to a fixed piece of code in an application layer of a blockchain that directly and automatically controls the transfer of digital assets between the parties under certain conditions.

“Metaverse” refers to a simulated digital environment that uses augmented reality (AR), virtual reality (VR), and blockchain.

A “web2 wallet” refers to a custodial digital wallet.

A “web3 wallet” or “crypto wallet” refers to a digital wallet that stores private keys, which are used to access and manage cryptocurrency and blockchain-based assets, such as NFTs. When a user creates a web3 wallet, the user is given a unique private key which is used to prove ownership of their digital assets. This private key is then used to generate a corresponding public key, which can be used to verify the authenticity of transactions. By using these keys together, a web3 wallet can enable digital identity and prove ownership of digital assets in a secure and decentralized way. A web3 can be a non-custodial wallet, a custodial wallet, or a smart contract wallet, as various examples.

A “private key” refers to a secret piece of information that is used to prove ownership of digital assets. It is used to sign transactions that are sent to the blockchain, and it is only known to the owner of the digital assets.

A “public key” refers to a piece of information that is used to prove that a transaction was signed by the owner of a digital asset. It is used to verify the authenticity of transactions and can be shared publicly.

A “public address” can be derived from the public key and can be shared publicly, allowing others to send digital assets to the user's wallet. By providing a unique public address, a web3 wallet can enable digital identity and prove ownership of digital assets in a secure and decentralized way.

A “transaction identifier”, or “transaction hash”, is a unique string of characters providing proof that a transaction has been verified and added to the blockchain. The transaction hash can be used to provide confirmation that the transaction was made and to look up transaction details, such as, but not limited to, sending address, receiving address, amount, date and time, network fees, and confirmations.

A “merchant” refers to a provider of goods or services in exchange for payment. The merchant can be physically present at the sale or remote, such as an online retailer.

An “acquirer” refers to a party that processes payments on behalf of the merchant in a payment card transaction. The acquirer can be a bank system or other institution associated with the merchant.

An “issuer” refers to a bank system or other institution that provides payment cards to the cardholder.

The terms “user”, “customer”, and “consumer” are used interchangeably herein.

An “oracle” refers to an application that sources, verifies, and transmits external information (i.e., information stored off of a blockchain) to smart contracts running on the blockchain.

Currently, there are many challenges to facilitating microtransactions. For instance, once challenge is that the cost of microtransactions can be high. These costs are often out of proportion to the total amount of the microtransaction itself. This is often because many microtransactions are conducted using the same technological infrastructure (e.g., systems, processing power, resource management, etc.) that is normally used for larger denomination transactions. In this case, the cost of facilitating the transaction is not reduced simply because the transaction amount is smaller, since the technical processing and resources remain the same. Therefore, participating in microtransactions using traditional payment pathways (e.g., credit card transactions) is not a popular or viable option for many users.

Recently, there has been a rise in web3 microtransaction solutions, specifically solutions involving blockchain and cryptocurrency platforms (e.g. Ethereum). However, using the current web3 microtransaction solutions has a high technological learning curve for most users. These web3 solutions often require users to understand web3/blockchain technology at a more advanced level. For example, a user may want to engage in a microtransaction in one type of cryptocurrency, but that user must download an application supporting that cryptocurrency, and acquire cryptocurrency, which generally requires signatures and the generation of public/private keys, which are concepts many users are unfamiliar with. Additionally, the user may be required to maintain a balance in an additional cryptocurrency (other than the one they intended to trade in) for paying associated gas fees (e.g., an Ether (ETH) balance is required to conduct a transaction Ethereum blockchain network).

It is challenging to support small transaction amounts on a payment network due to a variety of infrastructure requirements and blockchain/cryptocurrency solutions are not easily adoptable.

Consider a scenario where Alice wishes to read a single article from the online newspaper owned by Company B. Conventionally, Company B may require users to pay a fixed, monthly subscription cost, upon which, users gain unlimited access to the entire library of articles produced by the online newspaper. However, the current payment infrastructure does not easily support microtransactions were a charge/payment is made for individually accessed articles (at a cost compensating the value of a fractional portion, such as a single article, of an entire library). As such, Company B may not be able to implement a mechanism allowing for microtransaction payments for their services (e.g., access to individual articles.)

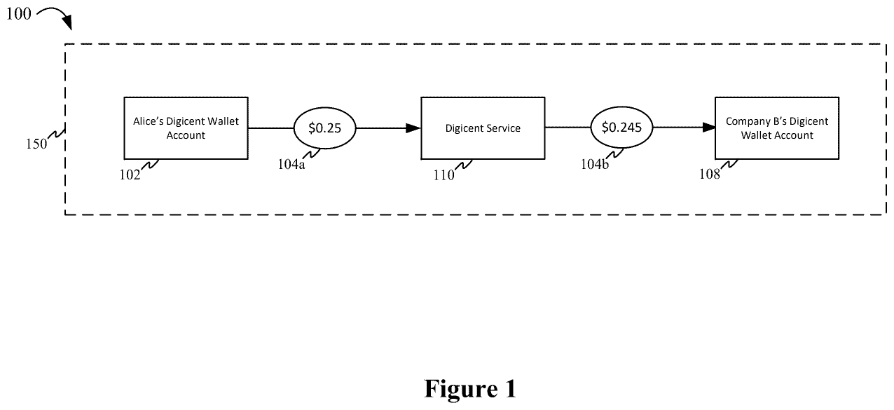

FIG. 1 illustrates an example scenario of a microtransaction of a fractional payment amount. Referring to FIG. 1, in the example microtransaction scenario 100, Alice wishes to purchase access to a single article available in the online newspaper owned by Company B.

Conventionally, Company B may require users to pay a fixed, monthly subscription cost, upon which, Alice could gain unlimited access to the entire library of articles produced by the online newspaper. However, Alice may only desire to gain access to a single article, preferably via a micropayment amount that is reasonably proportional to the value of single access to a single article (e.g., $0.25). However, the current payment infrastructure does not easily support microtransactions where a charge/payment is made for individually accessed articles (at a cost commensurate with a small portion of their entire library). As such, Company B may not be able to implement access to individual articles on a charge-per-article basis. Therefore, using conventional payment infrastructure, Alice's only option for accessing the single article she desires to read may be to pay the monthly subscription cost. In this scenario, both parties are disadvantaged: Alice does not get to read the article and Company B loses out on the profit they could have made using an existing asset in their library.

Advantageously, the described digicent service 110 can facilitate the microtransaction 104 (e.g., $0.25) in a cost-effective and user-friendly manner on the blockchain 150 using a digital currency. A microtransaction can be a transaction having a relatively small payment amount, including fractions of a dollar or even fractions of a cent. A fractional fiat currency transaction is a micropayment of a fraction of a single unit of fiat currency (e.g., 0.35 USD is a fraction of $1 USD). In some cases, a microtransaction can be sums that are relatively low in relation to a present value of a particular fiat currency (e.g., $1 USD, $5 USD, 150 yen, 1.38 Euro, etc.). In some cases, a microtransaction is a transaction having a value that is extremely small, such that it is unprofitable to process (e.g., via merchants, payment partners, etc.).

As shown in the first leg 104a of the microtransaction 104, $0.25 in digicents can be deducted from Alice's digicent wallet account 102 at the digicent service 110 on the blockchain 150.

The described digital currency, digicents (DGC), is pegged at a 1 to 1 fixed exchange rate with a particular fiat currency (e.g., USD) and each digicent token is backed by an equivalent fiat currency at the fixed rate. This allows a user to seamlessly conduct microtransactions on the blockchain 150 with minimal confusion and at a much lower risk than many other digital currencies. In some cases, digicent is a stablecoin. The digicent conforms to the technical standards for fungible tokens (e.g., ERC-20). In some cases, digicents is pegged 1 to 1 with a minor currency unit for a fiat currency. For example, a unit of a digital currency such as digicents can correspond to a minimum amount of fiat currency. In some cases, digicents is pegged to a lowest fractional monetary unit for a particular fiat currency (e.g., one-cent in USD, one-cent piece in CAD, the one-cent coin in AUD, etc.).

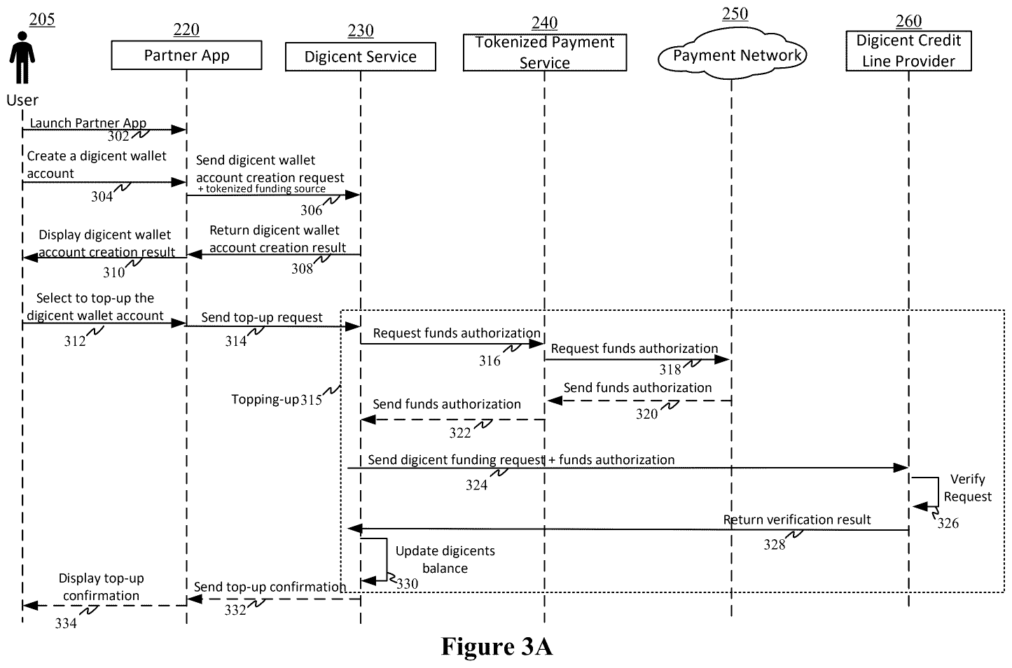

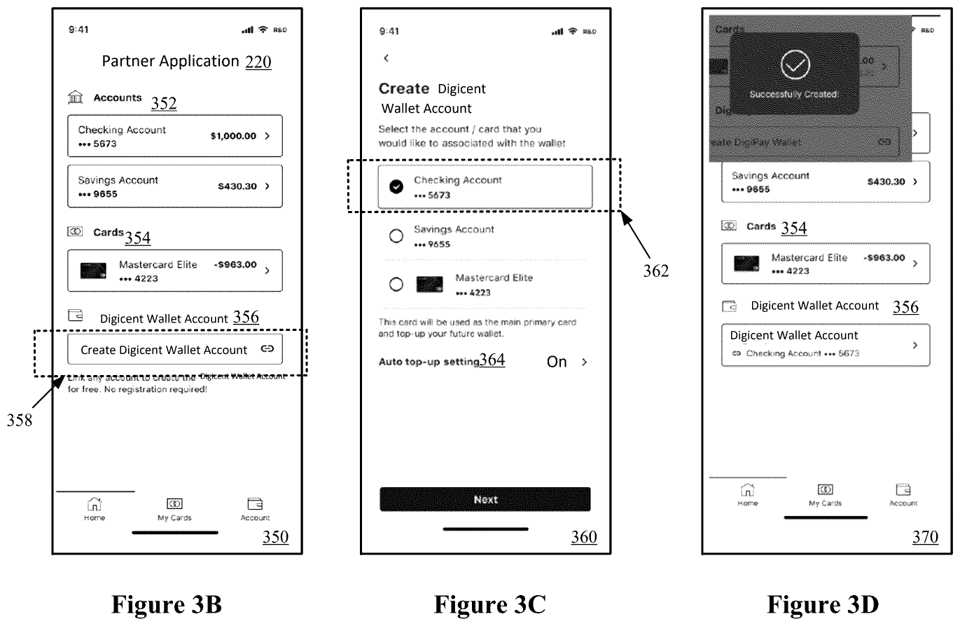

For example, in FIG. 1, in this scenario, DGC are pegged 1 to 1 with $0.01 USD. Advantageously, at a graphical user interface of Alice's digicent-enabled wallet (e.g., graphical user interface 350 described with respect to FIG. 3B), Alice may enter a transaction amount of $0.25 USD, despite the fact that Alice is actually transacting in DGC. This allows users to facilitate digital currency transactions using familiar fiat currency (e.g., USD), which reduces the burden of confusion that comes when users are transacting in digital currency, particularly digital currency with non-set exchange rates (e.g., memecoins). Additionally, the stability of DGC reduces the burden of risk for users, who may just want to conduct microtransactions and are not interested in keeping up or risking the complexities that often come with transacting in digital currency/cryptocurrency.

As shown in the second leg 104b of the microtransaction 104, $0.245 in digicents can be added to Company B's digicent wallet account 108 at the digicent service 110 on the blockchain 150. As can be seen, only a very small microtransaction fee of $0.005 is deducted (e.g., in comparison to a larger transaction fee that would be deducted if the microtransaction was made using traditional payment infrastructure). This microtransaction fee may be paid to the digicent service 110 for enabling this transaction or may go towards paying gas fees associated with cost of transacting on the blockchain 150.

A conventional payment processor, at the very least, would need to increase or decrease the microtransaction fee because the smallest fiat demonization is $0.01, making it impossible to credit Company B with $0.245. In this scenario, depending on the rounding policy, Company B would either receive $0.24 or $0.25, but likely only $0.24. Advantageously, using the systems and methods of the digicent service described herein, a balance of exactly $0.245 can be maintained in Company B's digicent wallet account 108.

Advantageously, the described systems and methods enable effective and efficient online infrastructure to enable microtransactions in a manner that makes microtransactions a viable option for all parties involved.

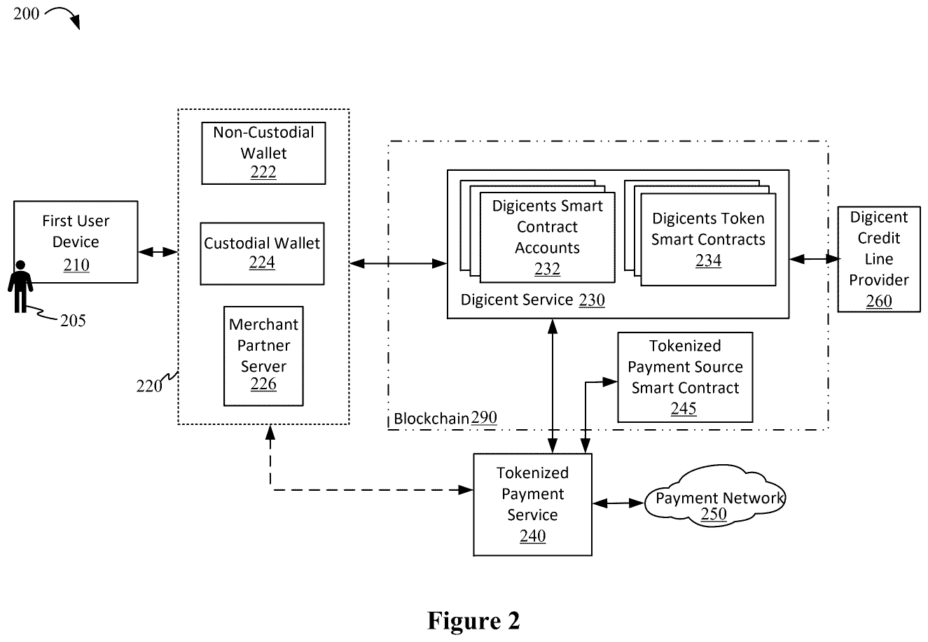

FIG. 2 illustrates an example operating environment for the digicent service. Referring to FIG. 2, the operating environment 200 includes a user device 210, a partner application 220, a digicent service 230, a tokenized payment service 240, a payment network 250, a digicent credit line provider 260, and a blockchain 290.

The digicent service 230 is a decentralized application (dApp) on the blockchain 290 that manages a plurality of digicent smart contract accounts 232 and a plurality of digicents token smart contracts 234. The digicent service 230 manages digicents and facilitates digicent transactions on the blockchain 290. In some cases, there may be additional smart contracts managed by the digicent service 230 that enable digicent microtransactions as described herein.

Each of the plurality of digicent token smart contracts 234 maintains an individual user's digicent balance on the blockchain 290. The digicent token smart contracts 234 store digicents on the blockchain 290.

Each of the plurality of digicent smart contract accounts 232 enables users to view, control, and/or manage the digicent balance that is stored by a corresponding digicent token smart contract (e.g., via a partner application 220). In some cases, each of the digicent smart contract accounts 232 and each of the digicent token smart contracts 234 are labeled on the blockchain 290 with an account abstraction (e.g., ERC-4337) smart contract type.

As used herein, an individual user's digicent smart contract account and digicent token smart contract can be referred to collectively as a user's “digicent wallet account.” An individual user owns their digicent wallet account (i.e., the user owns the corresponding smart contracts on the blockchain). For example, the user 205 may have a digicent wallet account at the digicent service 230. A user's digicent wallet account may have a corresponding digicent wallet account address. In some cases, the digicent wallet account address is the address of the digicent token smart contract and/or the digicent smart contract account on the blockchain 290.

A user (e.g., user 205) can interact with their digicent wallet account and the digicent service 230 on the blockchain 290 via a partner application 220. The partner application 220 (e.g., non-custodial wallet 222, custodial wallet 224, and/or merchant partner server 226) is an application running on the user device 210 that enables connectivity to the digicent service 230 operating on a blockchain 290. The partner application 220 can be used to store/manage balances of digicent tokens. The partner application 220 can enable a user 205 to authorize auto-top-ups and auto-withdrawals of their digicent wallet account balance.

The partner application 220 can be a mobile application, a browser extension, and/or another application capable of interacting with blockchain applications on the blockchain 290 and web3. A second user device can also interact with the digicent service 230 via their own instance of partner application 220.

As illustrated, in some cases, the partner application 220 can also communicate with the tokenized payment service 240.

A digicent wallet account is linked, verified, and funded by a tokenized payment source smart contract 245 (e.g., financial NFT, soul-bound token (SBT)) that represents a payment source (e.g., credit card, bank account, etc.) belonging to the user 205 that is tokenized on the blockchain 290.

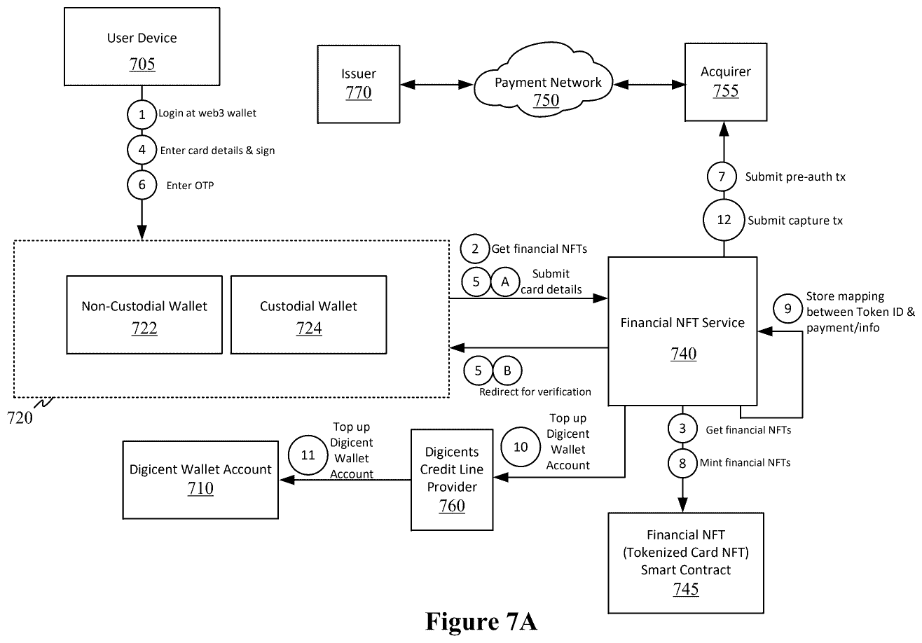

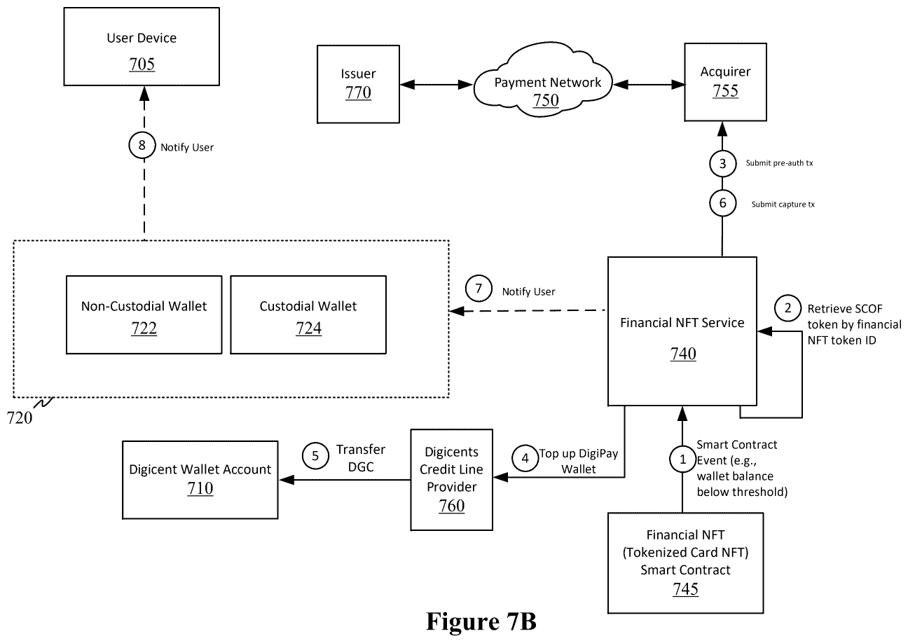

The tokenized payment service 240 can generate and/or manage a tokenized payment source (e.g., tokenized payment source smart contract 245) on the blockchain 290. As described with respect to FIGS. 7A and 7B, in some cases, the tokenized payment service 240 is a financial NFT service and the tokenized payment source smart contract 245 is a financial NFT on the blockchain 290. In some cases, the tokenized payment service 240 can be a service that tokenizes a user's 205 bank account to create a tokenized bank account on the blockchain 290.

The digicent credit line provider 260 mints DGC and manages the credit line float for DGC. In some cases, the digicent credit line provider 260 is a financial institution. In some cases, the digicent credit line provider 260 is a stablecoin operator.

The blockchain 290 can be a public or private blockchain supporting high TPS and low latency. In some cases, the blockchain 290 supports Account Abstraction standards (e.g., ERC-4337). For example, the blockchain 290 can be a layer 2 chains, specifically Zero knowledge rollsup which adhere to “Europay, Mastercard, and Visa” (EMV) compatibility.

The digicent service 230 can communicate with the tokenized payment service 240, and the digicent credit line provider 260 to facilitate the conversion of fiat currency (e.g., USD, CAD, etc.) managed with digicents.

Components (computing systems, storage resources, and the like) in the operating environment may operate on or in communication with each other over a network (not shown). The network can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as understood by those skilled in the art.

Communication to and from the components may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

FIG. 3A illustrates an example process for funding a digicent wallet account. FIGS. 3B-3D illustrate example representations of digicent wallet account management in a graphical user interface of a partner application supporting a digicent service.

Referring to FIGS. 3A-3D, the process of funding a digicent wallet account can begin when a user 205 launches (302) a partner application 220 on a user device (e.g., user device 210 as described with respect to FIG. 2).

As shown in FIG. 3B, graphical user interface (GUI) 350 can display a plurality of payment options that can be managed from the partner application 220 that supports management of a digicent wallet account on a blockchain. As can be seen, GUI 350 displays options for linking bank accounts 352, payment cards 354, and digicent wallet account 356. In some cases, where a user (e.g., user 205) does not already have a digicent wallet account, the user can be prompted to select a 358 “Create Digicent Wallet Account,” interactive option.

As shown in FIG. 3C, GUI 360 can display a create digicent wallet account view of the partner application 220. At GUI 360, a user can select 362 a payment method to be associated with the digicent wallet account 356 (e.g., a bank account from the linked bank accounts 352 as shown in GUI 350). In some cases, the payment method linked with the digicent wallet account is tokenized on the blockchain (e.g., tokenized payment source smart contract 245 described with respect to FIG. 2).

Referring to FIGS. 3A-3D, the user 205 can create (304) a digicent wallet account at the partner application 220 (e.g., by selecting 358 “Create Digicent Wallet Account” as shown in GUI 360 and selecting 362 a payment method at GUI 360). Creating (304) a digicent wallet account at the partner application 220 can include selecting a payment source for the digicent wallet account. In some cases, the payment source is a tokenized payment source that is tokenized on the blockchain.

The partner application 220 can send (306) a digicent wallet account creation request to the digicent service 230. In some cases, sending (306) the digicent wallet account creation request includes sending information associated with the tokenized payment source selected by the user 205. In some cases, the information associated with the tokenized payment source can include, but is not limited to, a token ID: unique identifier, Token URI: link to metadata, and Hashed primary account number (“PAN”): one-way hash of PAN.

In some cases, the tokenized payment source is a tokenized payment source smart contract on a blockchain (e.g., tokenized payment source smart contract 245 as described with respect to FIG. 2). In some cases, if the payment information received is not tokenized on the blockchain (e.g., credit card details/bank account information), the digicent service 230 can send the payment information to the tokenized payment service 240 and the tokenized payment service 240 can mint of a tokenized payment source (e.g., financial NFT or tokenized bank account) using the provided payment information (e.g., as described with respect to FIGS. 7A and 7B).

The digicent service 230 can return (308) a digicent wallet account creation result to confirm (or deny) the received digicent wallet account creation request. The partner application 220 can display (310) the digicent wallet account creation result.

For example, GUI 370, as shown in FIG. 3D, can display a digicent wallet account 156 successful creation view of the partner application 220. As shown in GUI 370, the digicent wallet account 356 has been created and is available for management from the partner application 220.

The user 205 can select (312) to top-up of the digicent wallet account with the tokenized payment source associated with the digicent wallet account. In some cases, creating (304) the digicent wallet account includes selecting (312) to top-up the digicent wallet account.

When the user selects (312) to top-up the digicent wallet account, their selection includes a top-up amount. In some cases, selecting (312) to top-up the digicent wallet account includes selecting a one-time top-up amount.

The partner application 220 can support auto-top up for a linked digicent wallet account. The user 205 can authorize the partner application 220 to do automatic and recurring top-up of digicents at a linked digicent wallet account. In some cases, selecting (312) to top-up the digicent wallet account includes authorizing a recurring auto top-up and selecting a recurring auto top-up amount.

For example, as shown in FIG. 3C, the GUI 360 displaying the create digicent wallet account view can also provide a user with an auto top-up setting 364, which allows a user to turn “ON” or turn “OFF” an auto top-up setting for the digicent wallet account. When “ON”, the auto-top up setting will automatically top-up the digicent wallet account with digicents upon a certain condition being reached. For example, if a user had selected to turn the auto top-up setting 364 on, when a balance of a user's digicent wallet account falls below a certain threshold, such as 500 DGC (e.g., $5.00), the digicent service will automatically facilitate a top-up of DGC to the digicent wallet account.

In some cases, the user 205 selects/inputs a top-up amount in fiat currency (e.g., $2.00, $5.00, etc.). In some cases, the user 205 selects/inputs a top-up amount in DGC (e.g., 200 DGC, 500 DGC, etc.).

The partner application 220 sends (314) a top-up request for the user's digicent wallet account to the digicent service 230. In some cases, (e.g., user 205 requests to auto-top up), the top-up request will include a request that the digicent service 230 update an auto top-up rule associated with the user's 205 digicent wallet account.

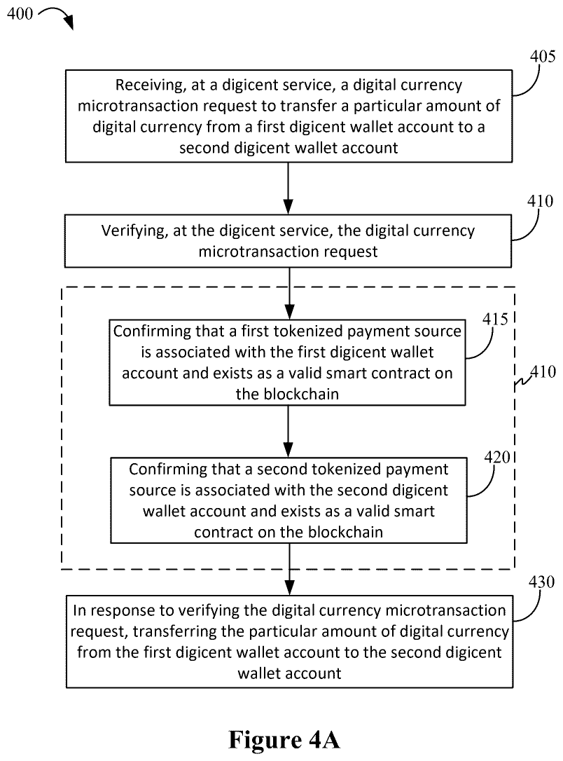

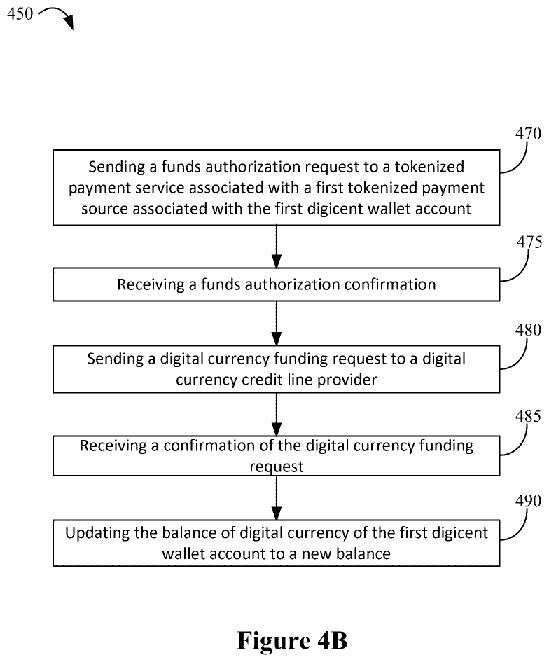

In response to receiving the top-up request, the digicent service 230 can top-up (315) the user's 205 digicent wallet account (e.g., via method 450 described with respect to FIG. 4B.) In some cases, in response to receiving the top-up request that includes an update to the auto top-up rule, the digicent service 230 will update the user's 205 digicent wallet account auto top up rule.

Topping-up (315) the user's digicent wallet account can include sending (316) a funds authorization request to the tokenized payment service 240 associated with the tokenized payment source received at step (306). In some cases, the funds authorization request includes the top-up amount. In some cases, the funds authorization request includes the token ID corresponding to the tokenized payment source.

The tokenized payment service 240 can send (318) a funds authorization request to the payment network 250 associated with the tokenized payment source. In some cases, the payment network 250 can pre-authorize the tokenized payment source for the top-up amount. The payment network 250 can send (320) a funds authorization confirmation to the tokenized payment service 240, authorizing the tokenized payment source for payment. In some cases, the funds authorization is for payment in the top-up amount. In response to receiving the funds authorization from the payment network 250, the tokenized payment service 240 can send (322) the funds authorization for the tokenized payment source to the digicent service 230.

Upon receiving the funds authorization for the tokenized payment source, the digicent service 230 can send (324) a digicent request to the digicent credit line provider 260. The digicent request can be a request for the digicent credit line provider 260 to transfer digicents in the top-up amount to the digicent service 230. The digicent request can include the funds authorization provided by the payment network 250. By including the funds authorization, the digicent credit line provider 260 has confirmation that the tokenized payment source is a reliable payment source. The digicent credit line provider 260 can verify (326) the digicent request.

In response to verifying (326) the digicent request, the digicent credit line provider 260 can transfer (328) digicents in the top-up amount to the digicent service 230. In response to receiving the transfer of digicents in the top-up amount, the digicent service 230 can update (330) the digicent balance at the digicent wallet account to include digicents in the top up amount.

The digicent service 230 sends (332) the top-up confirmation to the partner application 220 indicating that a digicent total in the top-up amount has been added to the user's 205 digicent wallet account. In response, the partner application 220 can display (334) the top-up confirmation for the user 205.

Advantageously, once the user's 205 digicent wallet account has been topped up, the user 205 can make micropayments using the digicents in their digicent wallet account.

FIG. 4A illustrates an example method for facilitating a microtransaction at a digicent service from a first digicent wallet account to a second digicent wallet account. Referring to FIG. 4A, method 400 can include receiving (405), at a digicent service, a digital currency microtransaction request to transfer a particular amount of digital currency from a first digicent wallet account to a second digicent wallet account, verifying (410), at the digicent service, the digital currency microtransaction request, and in response to verifying (410) the digital currency microtransaction request, transferring (430) the particular amount of digital currency from the first digicent wallet account to the second digicent wallet account. The method 450 can be performed by a digicent service on a blockchain (e.g., digicent service 230 described with respect to FIGS. 2, 3A, 5, and 6) and the digital currency can be digicents.

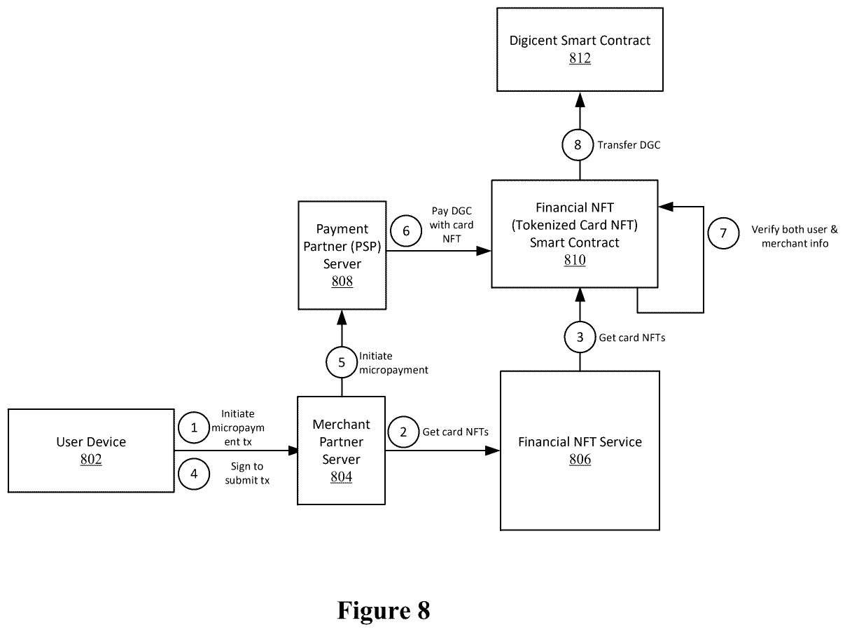

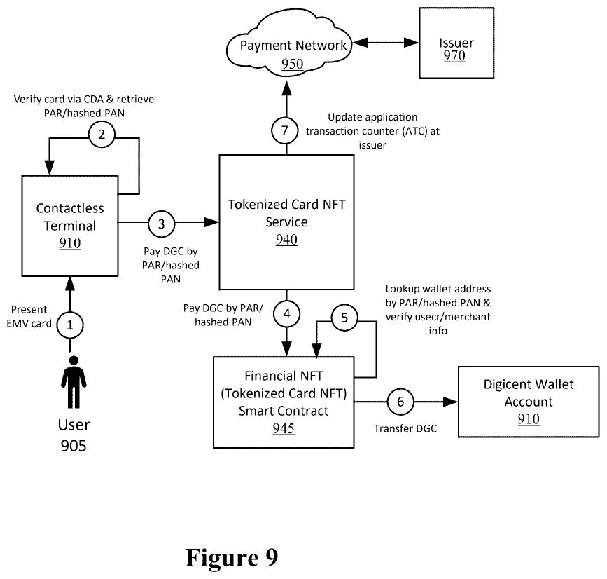

The digital currency microtransaction request can include a purchase identifier (ID) and the particular amount of digital currency. In some cases, the digicent service receives (405), the digital currency microtransaction request from a partner application (e.g., partner application 220 described with respect to FIG. 2). In some cases, (e.g., as described with respect to FIG. 8 and FIG. 9, the digicent service receives (405) the digital currency microtransaction request from a tokenized payment service (e.g., tokenized payment service 240 described with respect to FIG. 2, financial NFT service 740 described with respect to FIGS. 7A and 7B, financial NFT service 806 described with respect to FIG. 8, or financial NFT service 940 described with respect to FIG. 9).

Verifying (410) the digital currency microtransaction request can include confirming (415) that a first tokenized payment source is associated with the first digicent wallet account and exists as a valid smart contract on the blockchain and confirming (420) that a second tokenized payment source is associated with the second digicent wallet account and exists as a valid smart contract on the blockchain. After receiving (405), a digital currency microtransaction request to transfer a particular amount of digital currency from a first digicent wallet account to a second digicent wallet account, the digicent service may determine whether or not a balance of digital currency of the first digicent wallet account is equal to or greater than the particular amount of digital currency. If it is determined that the balance of digital currency of the first digicent wallet account is equal to or greater than the particular amount of digital currency, the digicent service will proceed to verifying (410) the digital currency microtransaction request.

If it is determined that balance of digital currency of the first digicent wallet account is not equal to or greater than the particular amount of digital currency, a topping-up event is triggered. In some cases, the topping-up event is triggered based on auto-top up rules associated with the first digicent wallet account. In some cases, the topping-up event is triggered by prompting the user at a partner application to manually request a top-up of the first digicent wallet. When a topping-up event is triggered, the digicent service can perform the top-up method 450 described with respect to FIG. 4B.

In some cases, confirming (415) that a first tokenized payment source is associated with the first digicent wallet account and exists as a valid smart contract on the blockchain includes sending a tokenized payment source existence request to a tokenized payment service associated with the first tokenized payment source and receiving a tokenized payment source confirmation. The tokenized payment source existence request can be a request for confirmation from the tokenized payment service that the tokenized payment source is associated with the first digicent wallet account and that the first tokenized payment source exists as a valid smart contract on the blockchain.

In some cases, confirming (420) that a second tokenized payment source is associated with a second digicent wallet account and exists as a valid smart contract on the blockchain includes sending a tokenized payment source existence request to a tokenized payment service associated with the second tokenized payment source and receiving a tokenized payment source confirmation.

FIG. 4B illustrates a process for topping up a digital currency balance of a digicent wallet account. Method 450 can be performed as part of method 400 when there are insufficient funds in a digicent account. The method 450 for topping up a digital currency balance at a digicent wallet account can include sending (470) a funds authorization request to a tokenized payment service associated with a first tokenized payment source associated with the first digicent wallet account, receiving (475) a funds authorization confirmation, sending (480) a digital currency payment request to a digital currency credit line provider, receiving (485) a confirmation of the digital currency payment request, and updating (490) the balance of digital currency of the first digicent wallet account to a new balance. The method 450 can be performed by a digicent service on a blockchain (e.g., digicent service 230 described with respect to FIGS. 2, 3A, 5, and 6).

In some cases, the method 450 for topping up a digital currency balance at a digicent wallet account can also include receiving, a top-up request requesting that a balance of digital currency at a digicent wallet account is topped up. The top-up request can include a top-up amount, a digicent token smart contract address corresponding to the digicent smart contract token associated with the user's digicent wallet account, a digicent smart contract account address corresponding to the digicent smart contract account associated with the user's digicent wallet account, a token ID corresponding to the first tokenized payment source. In some cases, the top-up request can include an auto-top up rule. An auto-top up rule authorizes automatic topping up of digicent balance at the first digicent wallet using the first tokenized payment source.

Sending (470) a funds authorization request to a tokenized payment service (e.g., tokenized payment service 240 described with respect to FIGS. 2, 3A, 5, and 6) associated with a first tokenized payment source associated with the first digicent wallet account can include identifying a first tokenized payment source associated with the first digicent wallet account. In some cases, identifying a first tokenized payment source associated with the first digicent wallet account can include receiving a top-up request including a token ID corresponding to the first tokenized payment source. In some cases, identifying a tokenized payment source associated with the first digicent wallet account can include looking-up (e.g., on the blockchain, at the digicent service) the token ID associated with a tokenized payment source associated with the first digicent wallet account.

The funds authorization request can include a token identifier (ID) corresponding to the tokenized payment source. In some cases, the funds authorization request can include a purchase ID associated with a microtransaction request.

Receiving (475) a funds authorization confirmation can include receiving a funds authorization confirmation from the tokenized payment service. In some cases, the funds authorization indicates authorization for payment via the tokenized payment source associated with the digicent wallet account in the top-up amount.

Sending (480) a digital currency funding request to a digital currency credit line provider (e.g., digicent credit line provider 260 described with respect to FIGS. 2, 3A, 5, and 6) can include sending a digital currency payment request for a top-up amount. In some cases, the digital currency payment request includes a top-up amount, the received funds authorization confirmation, a purchase ID, a digicent wallet account address corresponding to the first digicent wallet account, etc.).

In some cases, receiving (485) a confirmation of the digital currency funding request can include receiving a transfer of digital currency (e.g., DGC) in the top-up amount. In some cases, receiving (485) a confirmation of the digital currency funding request can include confirmation that digital currency in the top-up amount will be transferred to the digicent service.

In some cases, updating (490) the balance of digital currency of the first digicent wallet account to a new balance includes transferring a balance of digital currency in the top-up amount to the digicent token smart contract on the blockchain associated with first digicent wallet account. In some cases, updating (490) the balance of digital currency of the first digicent wallet account to a new balance includes updating the digicents smart contract account on the blockchain associated with the first digicent wallet to include the top-up amount.

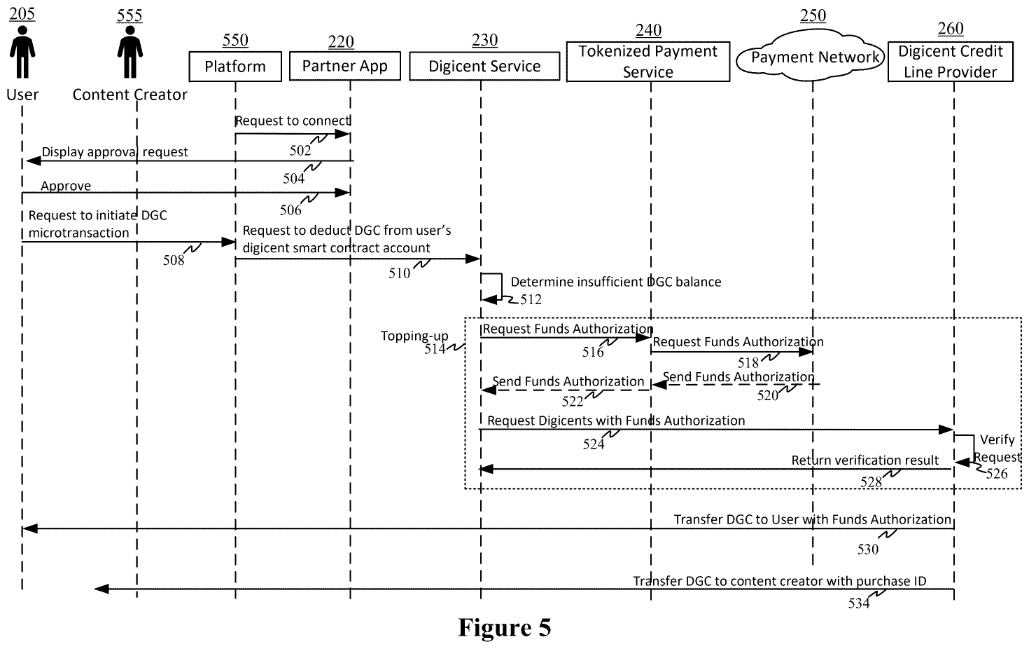

FIG. 5 illustrates a process of making a payment using a digicent wallet account that does not have a sufficient digicent balance. Referring to FIG. 5, in this illustrative process scenario, a user 205 wishes to give a small micropayment as a tip to a content creator 555 on a platform 550 (e.g., YouTube, TikTok, etc.).

In some cases, for the user 205 to initiate a micropayment at the platform 550, the user 205 must first connect their digicent wallet account to the platform 550. The platform 550 may send a request (502) to connect the user's 205 digicent wallet account to the partner application 220. The partner application 220 can display (504) an approval request for the user 205, requesting user's 205 approval (or denial) to connect the user's digicent wallet account to the platform 550. The user 205 can approve (506), via a user device running the partner application 220, the connection of the user's 205 digicent wallet account with the platform 550.

Once the digicent wallet application on the partner application 220 has been connected to the platform 550, the user 205 can request (508), at the platform 550, to initiate a digicent (DGC) microtransaction. The request (508) to initiate a DGC microtransaction includes a microtransaction amount (e.g., a DGC amount). For example, the user 205 may be requesting (508) to initiate a DGC microtransaction to donate 35 DGC (digicents) to content creator 555. In some cases, requesting (508) to initiate a DGC microtransaction can include an authorization for reoccurring payment from the digicent wallet account to platform 550 (e.g., reoccurring payment of microtransaction amount).

In response to receiving the request to initiate a digicent microtransaction, the platform 550 can send (510) a request to the digicent service 230 to deduct the microtransaction amount of DGC from user's digicent wallet account (e.g., request to deduct 35 DGC). In some cases, sending (510) the request to the digicent service 230 includes sending a purchase ID associated with the microtransaction. In some cases, sending (510) the request to the digicent service 230 includes sending a blockchain address associated with the user's 205 digicent wallet account. In some cases, sending (510) the request to the digicent service 230 includes a request to update a recurring payment rule at the digicent service 230.

Upon receiving the request to initiate a digicent microtransaction, the digicent service 230 can determine (512) that the user's 205 digicent wallet account balance (e.g., DGC balance) is less than the microtransaction amount (e.g., the user's 205 digicent wallet account balance is 20 DGC).

In response to determining that the user's 205 digicent wallet account balance is less than the microtransaction amount, the digicent service 230 triggers a topping-up event. In some cases, a topping-up event includes sending a notification to the user 205 that the balance is insufficient to initiate a manual top-up event (e.g., user 205 manually selects to top-up account). In some cases, a topping-up event includes an auto-top up triggered by rules and/or standards associated with the user's 205 digicent wallet account balance.

Topping-up (514) the user's 205 digicent wallet account can include sending (516) a funds authorization request to the tokenized payment service 240 associated with a tokenized payment source associated with the user's 205 digicent wallet account. In some cases, the funds authorization request includes the DGC amount indicated in the microtransaction request. In some cases, the funds authorization request includes a DGC top-up amount preauthorized by the user 205.

The tokenized payment service 240 can send (518) a funds authorization request to the payment network 250 associated with the tokenized payment source. In some cases, the payment network 250 can pre-authorize the tokenized payment source for the top-up amount. The payment network 250 can send (520) a funds authorization confirmation to the tokenized payment service 240, authorizing the tokenized payment source for payment. In some cases, the funds authorization is for payment in the top-up amount. In response, the tokenized payment service 240 can send (522) the funds authorization for the tokenized payment source to the digicent service 230.

The digicent service 230 can then send (524) a digicent request to the digicent credit line provider 260. The digicent request can be a request for the digicent credit line provider 260 to transfer digicents in the amount authorized by the funds authorization confirmation (e.g., 35 DGC) to the digicent service 230. The digicent request can include the funds authorization provided by the payment network 250. By including the funds authorization, the digicent credit line provider 260 has confirmation that the tokenized payment source is a reliable payment source. The digicent credit line provider 260 can verify (526) the digicent request. Verifying (526) the digicent request can include verifying that the fiat transaction is authorized before the digicents are disbursed.

In response to verifying (526) the digicent request, the digicent credit line provider 260 returns (584) a verification result. In response to receiving (528) the verification result, the digicent service 230 can transfer (530) the digicents in the top-up amount minus the microtransaction amount to the user's 205 digicent wallet account and transfer (532) digicents in the microtransaction amount to the content creator's 555 digicent wallet account.

The digicent credit line provider 260 can transfer (530) digicents to the user 205 with the funds authorization. The digicent credit line provider 260 can transfer (532) digicents to the content creator 555 with the purchase ID.

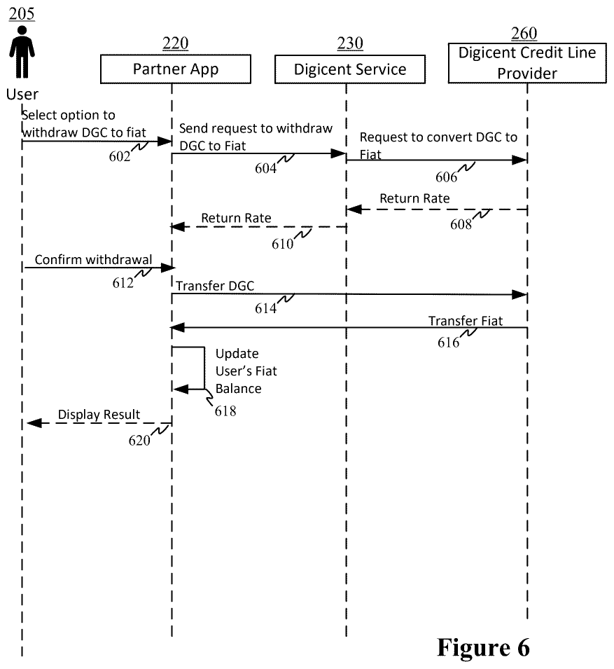

FIG. 6 illustrates an example process for cashing out DGC for fiat currency.

Referring to FIG. 6, a process for cashing out DGC for fiat currency can include the user 205 selecting (602) an option at the partner application 220 to withdraw DGC to fiat currency. Selecting (602) an option to withdraw DGC to fiat currency can include selecting the withdrawal amount, indicating the total DGC the user 205 wishes to exchange for fiat currency. In some cases, the withdrawal amount can be the entire DGC balance of the user's 205 digicent wallet account. In some cases, the withdrawal amount can be a partial DGC balance of the user's 205 digicent wallet account. In some cases, the user 205 may enable an auto-withdrawal rule associated with the digicent wallet account. For example, if the DGC balance is above 500 DGC (e.g., $5.00 USD), it will automatically trigger a withdrawal. In some cases, the partner application 220 monitors auto-withdrawal (e.g., automatically sends request to digicent service 230). In some cases, the auto-withdrawal is a rule at the digicent service (e.g., a rule enabled at a smart contract associated with user's digicent wallet account).

The partner application 220 can then send a request (604) to withdraw DGC to fiat currency to the digicent service 230. Sending the request (604) to withdraw DGC to fiat currency to the digicent service 230 can include sending the withdrawal amount selected by the user 205.

The digicent service 230 can send (606) a DGC conversion request to the digicent credit line provider 260. The DGC conversion request can include the withdrawal amount. The DGC conversion request requests that DGC in the withdrawal amount be converted to fiat currency by the digicent credit line provider 260. In response, the digicent credit line provider 260 can return (608) the rate of exchange to the digicent service 230, which can then send (610) the rate of exchange to the partner application 220 for display for the user 205.

The user can confirm (612) the withdrawal at the exchange rate displayed at the partner application 220. In response to the user's confirmation, the partner application 220 can transfer (614) DGC in the withdrawal amount to the digicent credit line provider 260. In response to receiving (614) the DGC, the digicent credit line provider can transfer (616) fiat currency in the withdrawal amount to the partner application 220. The partner application 220 can update (618) the user's fiat balance as stored in the partner application 220. The partner application 220 can display (620) the updated fiat balance for the user 205.

FIG. 7A illustrates an example process funding a digicent wallet account using a financial NFT. Referring to FIG. 7A, a process for funding a user's digicent wallet account using a financial NFT can start at step (1) with a user, via a user device 705, logging into a web3 wallet 720 (e.g., non-custodial wallet 722 or custodial wallet 724) (e.g., partner application 220 described with respect to FIG. 2).

At step (2) web3 wallet 720 can communicate with a financial NFT service to retrieve the user's financial NFTs (if any) managed by the financial NFT service 740. The financial NFT service 740 communicates with the financial NFT smart contract 745 on the blockchain to retrieve the user's financial NFTs (if any).

At step (4), the user can enter payment card details for a payment card the user wishes to mint into a financial NFT and sign at the web3 wallet 720. At step (5A), the web3 wallet 720 submits a financial NFT creation request including the payment card details to the financial NFT service 740. At step (5A) the financial NFT service 740 redirects to the web3 wallet 720 to prompt verification (e.g., one-time-password (OTP) verification/3DS) verification. Once prompted, the user can enter an OTP or other verification method to verify the minting of the financial NFT.

At step (7), the financial NFT service 740 submits a pre-authorization transaction to the acquirer 755 associated with the payment card being minted into a financial NFT. Once pre-authorized, at step (8) the financial NFT service 740 sends a financial NFT creation request to the financial NFT smart contract 745. In some cases, the financial NFT creation request includes the validation of the payment card, a hashed PAN of the payment card, and the token unique reference (TUR) of the payment card. This results in a financial NFT minted corresponding to the payment card.

At step (9), the financial NFT service 740 can store a mapping of a financial NFT identifier (e.g., token ID), the hashed PAN, and/or user's web3 wallet 720 address of the crypto wallet. The financial NFT appears on the blockchain to be owned by the user.

At step (10), the financial NFT service 740 (e.g., via a digicent service) can initiate a top-up of a user's digicent wallet account using the financial NFT as a tokenized payment source. with authorization associated with the minted financial NFT to a digicents credit line provider 760.

At step (11) a digicent wallet account of a user can be topped up with digicents provided by the digicents credit line provider 760.

FIG. 7B illustrates an example process for topping up a user's digicent wallet account using a financial NFT. Referring to FIG. 7A, the example process for topping up a user's digicent wallet account using a financial NFT can start at step (1), where a smart contract event (e.g., digicent wallet account balance is below a certain threshold) is triggered at a digicent wallet account associated with the financial NFT smart contract 745. The financial NFT smart contract 745 and/or financial NFT service 740 monitors blockchain events emitted by the financial NFT smart contract (which is associated with a digicent wallet account) to enable auto-top up and auto-withdrawal.

At step (2), the financial NFT service can retrieve a secure-card-on-file (SCOF) token using the financial NFT token ID.

At step (3), the financial NFT service submit a pre-authorization transaction to the acquirer 755 associated with the SCOF token for a top-up amount.

At step (4), the financial NFT service 740 can request DGC to top up the user's digicent wallet account 710 using the pre-authorization.

At step (5), the digicents credit line provider 760 can transfer DGC in the top up amount to the user's digicent wallet account 710.

At step (6), the financial NFT service 740 can submit a capture transaction for the top-up amount using the SCOF token for the top-up amount.

At step (7), the financial NFT service 740 can send a notification to the web3 wallet 720 notifying the user that the auto-top up was successful.

At step (8), the web3 wallet 720 can display the notification to the user.

FIG. 8 illustrates an example scenario for a digicent microtransaction originating at an online merchant. Referring to FIG. 8, the digicent microtransaction originating at an online merchant can begin at step (1), when a user, via a user device 802, initiates a microtransaction at a merchant partner server 804 of an online merchant (e.g., Amazon, New York Times, etc.).

In some cases, the user, via the user device 802 can initiate the microtransaction by providing financial NFT information (e.g., a financial NFT token ID) to the merchant partner server 804.

At step (2), the merchant partner server 804 can communicate with a financial NFT service 806, to get financial NFT information for a financial NFT associated with the user's digicent smart contract account (e.g., financial NFT token ID).

At step (3), the financial NFT service 806 will communicate with the financial NFT smart contract 810 on the blockchain to get the financial NFT. If there is no financial NFT minted for the user, the user will be redirected to an onboarding process (e.g., via the process described with respect to FIG. 7A).

At step (4), the user will receive a prompt via the user device 802 to sign to submit the transaction (e.g., user provides a private key). Once the user has signed to submit the transaction, at step (5), the merchant partner server 804 initiates a microtransaction (e.g., user micropayment to online merchant) at the payment partner (PSP) server 808.

At step (6), the payment partner server 808 will pay the micropayment in DGC using the associated financial NFT. At step (7), the financial NFT smart contract will verify the user information and the online merchant information. Verifying the user information can include verifying that the user's financial NFT exists as a valid smart contract on the blockchain. Verifying the online merchant information can include verifying that a financial NFT associated with the online merchant exists as a valid smart contract on the blockchain. Upon successful verification, at step (8), the financial NFT smart contract will transfer DGC at the digicent smart contract 812.

FIG. 9 illustrates an example scenario for a digicent microtransaction originating at a point-of-sale (POS) terminal. The example scenario for a digicent microtransaction originating at a POS terminal can begin when a user 905 presents a payment card at a contactless terminal 910. The payment card can be a smart payment card (e.g., “Europay, Mastercard, and Visa”, “EMV” payment card).

At step (2), the contactless terminal 910 can verify the payment card information. In some cases, the contactless terminal 910 verifies the payment card information via combined dynamic data authentication (CDA). CDA can include retrieving a payment account reference (PAR) and/or hashed personal account number (PAN) associated with a financial NFT associated with the payment card.

The contactless terminal 910 can determine that the transaction includes a microtransaction (e.g., transaction amount vs. small merchant processing fee, etc.). The contactless terminal 910 can use smart routing capabilities to determine not to charge the payment card presented through a traditional payment network. Because the contactless terminal 910 determined that the transaction included a microtransaction, the contactless terminal 910 can run the microtransaction using digicents.

At step (3), the contactless terminal 910 pay in digicents by sending the PAR and/or hashed PAN to the tokenized card NFT service 940. At step (4), the tokenized card NFT service 940 can pay in digicents by sending the PAR and/or hashed PAN to the financial NFT smart contract 945.

At step (5), the financial NFT smart contract 945 can look up a digicent wallet account address and verify the user and/or merchant information. The financial NFT smart contract 945 can look up a digicent wallet account address using the PAR and/or hashed PAN of the financial NFT associated with the digicent wallet account. Verifying the user information can include verifying that the user's financial NFT exists as a valid smart contract on the blockchain. Verifying the online merchant information can include verifying that an financial NFT associated with the online merchant exists as a valid smart contract on the blockchain.

At step (6), the financial NFT smart contract 945 can initiate the transfer of DGC to the digicent wallet account 910.

At step (7), the financial NFT service 940 can update the application transaction counter (ATC) at the issuer 950 associated with the financial NFT.

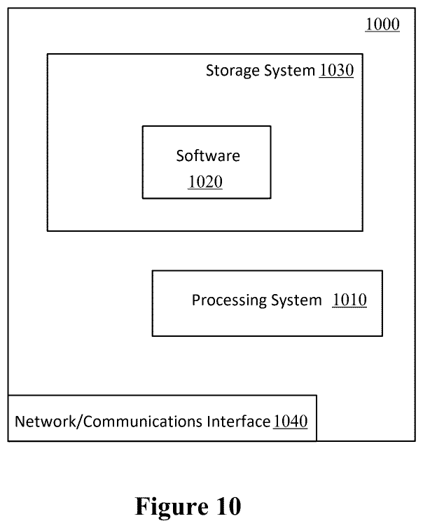

FIG. 10 illustrates components of a computing system that may be used in certain embodiments described herein. Referring to FIG. 10, system 1000 may be implemented within a single computing device or distributed across multiple computing devices or sub-systems that cooperate in executing program instructions. The system 1000 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 1000 can include a processing system 1010, which may include one or more processors and/or other circuitry that retrieves and executes software 1020 from storage system 1030. Processing system 1010 may be implemented within a single processing device but may also be distributed across multiple processing devices or sub-systems that cooperate in executing program instructions.

Storage system(s) 1030 can include any computer readable storage media readable by processing system 1010 and capable of storing software 1020. Storage system 1030 may be implemented as a single storage device but may also be implemented across multiple storage devices or sub-systems co-located or distributed relative to each other. Storage system 1030 may include additional elements, such as a controller, capable of communicating with processing system 1010. Storage system 1030 may also include storage devices and/or sub-systems on which data is stored. System 1000 may access one or more storage resources in order to access information to carry out any of the processes indicated by software 1020.

Software 1020, including routines for performing processes, may be implemented in program instructions and among other functions may, when executed by system 1000 in general or processing system 1010 in particular, direct the system 1000 or processing system 1010 to operate as described herein. For example, software 1020 can include, but is not limited to, instructions for digicent service 230 and methods 400 and 450.

In embodiments where the system 1000 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 1040 may be included, providing communication connections and devices that allow for communication between system 1000 and other computing systems (not shown) over a communication network or collection of networks (not shown) or the air.

In some embodiments, system 1000 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method, comprising:
receiving, at a digicent service on a blockchain, a digital currency microtransaction request to transfer a particular amount of digital currency from a first digicent wallet account to a second digicent wallet account, wherein the digital currency microtransaction request comprises a purchase identifier (ID) and the particular amount, and wherein a microtransaction is a fractional fiat currency transaction;
verifying, at the digicent service, the digital currency microtransaction request, wherein verifying the digital currency microtransaction request comprises:
confirming that a first tokenized payment source is associated with the first digicent wallet account;
confirming that the first tokenized payment source exists as a first valid smart contract on the blockchain;
confirming that a second tokenized payment source is associated with the second digicent wallet account; and
confirming that the second tokenized payment source exists as a second valid smart contract on the blockchain; and
in response to verifying the digital currency microtransaction request, transferring the particular amount of digital currency from the first digicent wallet account to the second digicent wallet account.

2. The method of claim 1, wherein verifying the digital currency microtransaction request further comprises determining whether or not a balance of digital currency of the first digicent wallet account is equal to or greater than the particular amount.

3. The method of claim 2, the method further comprising:
in response to determining that the balance of the digital currency of the first digicent wallet account is not equal to or greater than the particular amount, triggering a topping up event for the first digicent wallet account; and
topping up the first digicent wallet account, wherein topping up the first digicent wallet account comprises:
sending a funds authorization request to a tokenized payment service associated with a first tokenized payment source associated with the first digicent wallet account, wherein the funds authorization request comprises a token identifier (ID) corresponding to the first tokenized payment source and the purchase ID;
receiving, at the digicent service, a funds authorization confirmation;
in response to receiving the funds authorization confirmation, sending a digital currency funding request to a digital currency credit line provider, wherein the digital currency funding request comprises a top-up amount and the received funds authorization confirmation;
receiving, at the digicent service, a confirmation of the digital currency funding request; and
updating, at the digicent service, the balance of digital currency of the first digicent wallet account to a new balance including a digital currency amount in the top-up amount.

4. The method of claim 1, wherein the first digicent wallet account comprises a digicent smart contract account on the blockchain and a digicent token smart contract on the blockchain, wherein the digicent token smart contract is the first valid smart contract.

5. The method of claim 1, wherein a unit of digital currency corresponds to a minimum amount of fiat currency.

6. The method of claim 1, wherein the first tokenized payment source is a financial NFT.

7. The method of claim 1, wherein triggering a topping up event comprises identifying, at the digicent service, an authorized auto-top up rule associated with the first digicent wallet account.

8. A system comprising:
a processing system;
one or more storage media; and
instructions stored on the one or more storage media that, when executed by the processing system, direct the processing system to at least:
receive, at a digicent service on a blockchain, a digital currency microtransaction request to transfer a particular amount of digital currency from a first digicent wallet account to a second digicent wallet account, wherein the digital currency microtransaction request comprises a purchase identifier (ID) and the particular amount, and wherein a microtransaction is a fractional fiat currency transaction;
verify, at the digicent service, the digital currency microtransaction request, wherein the instructions that direct the digicent service to verify the digital currency microtransaction request further direct the system to:
confirm that a first tokenized payment source is associated with the first digicent wallet account;
confirm that the first tokenized payment source exists as a valid first smart contract on the blockchain;
confirm that a second tokenized payment source is associated with the second digicent wallet account; and
confirm that the second tokenized payment source exists as a second valid smart contract on the blockchain; and
in response to verifying the digital currency microtransaction request, transfer the particular amount of digital currency from the first digicent wallet account to the second digicent wallet account.

9. The system of claim 8, wherein the instructions that direct the digicent service to verify the digital currency microtransaction request further direct the system to determine whether or not a balance of digital currency of the first digicent wallet account is equal to or greater than the particular amount.

10. The system of claim 9, wherein the instructions further direct the system to:
in response to determining that the balance of the digital currency of the first digicent wallet account is not equal to or greater than the particular amount, trigger a topping up event for the first digicent wallet account; and
top-up the first digicent wallet account, wherein the instructions to top-up the first digicent wallet account further direct the system to:
send a funds authorization request to a tokenized payment service associated with a first tokenized payment source associated with the first digicent wallet account, wherein the funds authorization request comprises a token identifier (ID) corresponding to the first tokenized payment source and the purchase ID;
receive, at the digicent service, a funds authorization confirmation;
in response to receiving the funds authorization confirmation, send a digital currency funding request to a digital currency credit line provider, wherein the digital currency funding request comprises a top-up amount and the received funds authorization confirmation;
receive, at the digicent service, a confirmation of the digital currency funding request; and
update, at the digicent service, the balance of digital currency of the first digicent wallet account to a new balance including a digital currency amount in the top-up amount.

11. The system of claim 8, wherein the first digicent wallet account comprises a digicent smart contract account on the blockchain and a digicent token smart contract on the blockchain, wherein the digicent token smart contract is the first valid smart contract.

12. The system of claim 8, wherein a unit of digital currency corresponds to a minimum amount of fiat currency.

13. The system, of claim 8, wherein the first tokenized payment source is a financial NFT.

14. The system of claim 8, wherein the instructions to trigger a topping up event further direct the system to identify, at the digicent service, an authorized auto-top up rule associated with the first digicent wallet account.

15. One or more computer readable storage media having instructions stored thereon that, when executed by a processing system, direct the processing system to perform a method comprising:
receiving, at a digicent service on a blockchain, a digital currency microtransaction request to transfer a particular amount of digital currency from a first digicent wallet account to a second digicent wallet account, wherein the digital currency microtransaction request comprises a purchase identifier (ID) and the particular amount, and wherein a microtransaction is a fractional fiat currency transaction;
verifying, at the digicent service, the digital currency microtransaction request, wherein verifying the digital currency microtransaction request comprises:
confirming that a first tokenized payment source is associated with the first digicent wallet account;
confirming that the first tokenized payment source exists as a first valid smart contract on the blockchain;
confirming that a second tokenized payment source is associated with the second digicent wallet account; and
confirming that the second tokenized payment source exists as a second valid smart contract on the blockchain; and
in response to verifying the digital currency microtransaction request, transferring the particular amount of digital currency from the first digicent wallet account to the second digicent wallet account.

16. The method of claim 1, wherein the first tokenized payment source comprises the first smart contract representing a payment source belonging to a user associated with the first digicent wallet account.

17. The method of claim 1, wherein confirming that the first tokenized payment source is associated with the first digicent wallet account and exists as the first valid smart contract on the blockchain comprises:
sending a first tokenized payment source existence request to a first tokenized payment service associated with the first tokenized payment source; and
receiving a first tokenized payment source confirmation; and
wherein confirming that the second tokenized payment source is associated with the second digicent wallet account and exists as a valid smart contract on the blockchain comprises:
sending a second tokenized payment source existence request to a second tokenized payment service associated with the second tokenized payment source; and
receiving a second tokenized payment source confirmation.

18. The method of claim 2, the method further comprising:
in response to determining that the balance of the digital currency of the first digicent wallet account is not equal to or greater than the particular amount, triggering a topping up event for the first digicent wallet account; and
topping up the first digicent wallet account with a value at least equal to or greater than the particular amount, wherein topping up the first digicent wallet account occurs prior to transferring the particular amount of digital currency from the first digicent wallet account to the second digicent wallet account.

19. The system of claim 9, wherein the instructions further direct the system to:
in response to determining that the balance of the digital currency of the first digicent wallet account is not equal to or greater than the particular amount, trigger a topping up event for the first digicent wallet account; and
top up the first digicent wallet account with a value at least equal to or greater than the particular amount, wherein topping up the first digicent wallet account occurs prior to transferring the particular amount of digital currency from the first digicent wallet account to the second digicent wallet account.
